(19) United States
(12) Patent Application Publication
(10) Pub. No.: US 2003/0194689 A1
(43) Pub. Date: Oct. 16, 2003

(54) Structured document type determination system and structured document type determination method

(75) Inventors: Hitoshi Kamasaka, Tokyo (JP); Tsuyoshi Higuchi, Tokyo (JP); Junichi Kitsuki, Tokyo (JP); Toshiyuki Kimura, Tokyo (JP); Takayuki Tamura, Tokyo (JP)

Correspondence Address: LEYDIG VOIT & MAYER, LTD, 700 THIRTEENTH ST. NW, SUITE 300, WASHINGTON, DC, 20005-3960, US

(73) Assignee: Mitsubishi Denki Kabushiki Kaisha, Tokyo (JP)

(21) Appl. No.: 10/277,820

(22) Filed: Oct. 23, 2002

(30) Foreign Application Priority Data
Apr. 12, 2002 (JP) 2002-111288

(51) Int. Cl. G09B 3/00

(52) U.S. Cl. 434/350; 434/362; 434/323

(57) ABSTRACT

A structured document type determination system is provided with a feature value extraction unit for extracting a value of each of a plurality of features included in a feature list which is disposed in advance from each of a plurality of structured documents and a determination rule creating unit for creating a determination rule from extracted feature values by using a data mining tool. The structured document type determination system makes an evaluation of the determination rule by comparing results of determining the types of structured documents according to the determination rule and teacher data, and repeatedly delivers a tuning parameter to the data mining tool so as to create a plurality of determination rules and to derive an optimum determination rule.

### BACKGROUND OF THE INVENTION

1. Field of the Invention

The present invention relates to a structured document type determination system for and a structured document type determination method of determining the type of a structured document, such as a Web page written in HTML (HyperText Markup Language) or the like.

2. Description of Related Art

FIG. 21 is a block diagram showing the structure of a prior art structured document type determination system disclosed in Japanese patent application publication No. 2000-29902. In the figure, reference numeral 400 denotes a structured document type determination apparatus, reference numeral 410 denotes a structural feature extraction unit, which includes a key word feature extraction unit 411 for extracting structural features which consist of a pair of tags and key words from each HTML document stored in a text database 500, an image feature extraction unit 412 for extracting features of each image included in each HTML document, a link feature extraction unit 413 for extracting features of each link included in each HTML document, and a tag structure feature extraction unit 414 for extracting features of a tag structure of each HTML document Reference numeral 420 denotes a structural feature rule base including rules used for grading the structural features extracted by the structural feature extraction unit 410, reference numeral 430 denotes a comparing unit for comparing the structural features extracted by the structural feature extractor 410 with rules so as to grade each of a plurality of types into which each HTML document is to be classified and to calculate the degree of match of each HTML document with each of the plurality of types, and reference numeral 600 denotes a type index for holding information on the type of each HTML document determined by the structured document type determination apparatus 400.

Next, a description will be made as to the operation of the prior art structured document type determination system. The structured document type determination apparatus 400 extracts each HTML document from the text database 500 one by one, and then delivers them to the structural feature extractor 410. The structural feature extractor 410 starts the key word feature extraction unit 411, the image feature extraction unit 412, the link feature extraction unit 413, and the tag structure feature extraction unit 414 so as to extract features included in each of the plurality of HTML documents applied thereto and to send them to the comparing unit 430. The structural feature rule base 420 contains rules, as shown in FIG. 22, each of which is used to determine the type of each of the plurality of HTML documents and each of which represents a condition in which features corresponding to a type are described and a point. Each rule shown in FIG. 22 has a format of “keyword, image, link or structure: type: point: tag or conditional expression: key word list or conditional expression”. In the case of a rule whose first term is “keyword”, the rule corresponds to the key word feature extraction unit 411. In the case of a rule whose first term is “image”, the rule corresponds to the image feature extraction unit 412. In the case of a rule whose first term is “link”, the rule corresponds to the link feature extraction unit 413. In the case of a rule whose first term is “structure”, the rule corresponds to the tag structure feature extraction unit 414. The second term shows that the rule in question is a rule specific to a certain type, and the third term indicates a point to be added to the total sum of points given to the type when determined that the HTML document in question is of the certain type. When the first term is “keyword”, the fourth term shows a tag in which key words are included. When the first term is “image” or “link”, the fourth term shows a conditional expression associated with an image file or a link. When the first term is “structure”, the fourth term shows a partial tag structure to be extracted. When the first term is “keyword”, the fifth term shows a list of key words included in the tag defined by the fourth term. When the first term is “structure”, the fifth term, which is an option, shows a conditional expression for variables in a tag structure or the number of tag structures. There is no fifth term when the first term is “image” or “link”.

The comparing unit 430 compares features that are extracted from each HTML document, which is to be classified into a document type, and that are sent from the structural feature extractor 410 with each of a plurality of determination rules defined, as shown in FIG. 22, for each type. In this case, when there is agreement between the extracted features and a judgement rule, the comparing unit 430 adds a point set to the rule to the total point of a corresponding type. For example, the rule listed in the fourth row of FIG. 22 means that 3 points are added to the total point of “goods catalog” type when the <h1> tag contains a key word: “ [symbol] (specification)” or “ [symbol] (spec)”. The comparing unit 430 calculates the degree of match with each of the plurality of types for each HTML document which is to be classified and stores it in the type index 600. For each HTML document which is to be classified, the comparing unit 430 calculates, as the degree of match with each of the plurality of types, a ratio of the total sum of acquired points for each of the plurality of types to the full mark when all rules defined for each of the plurality of types are satisfied. The structured document type determination apparatus 400 then classifies each HTML document into a specific type according to the calculated degree of match with each of the plurality of types.

The prior art structured document type determination system, as shown in FIG. 21, can have a point adjustment unit for finely adjusting the degree of match with each of the plurality of types, which can be calculated by the comparing unit 430. The point adjustment unit can finely adjust the degree of match with each of the plurality of types by using one or more adjustment rules, as shown in FIG. 23, used for the fine adjustment according to relationships among the plurality of types or the like. For example, the first rule of FIG. 23 means that when the difference between the degree of match with “goods catalog” and that with “individual page” is greater than 0% and is equal to or less than 10%, the degree of match with “individual page” is equal to or greater than 50%, and the degree of match with “goods catalog” is equal to or less than 90%, the degree of match with “goods catalog” is raised by 10% and the degree of match with “individual page” is lowered by 10%”.

The prior art structured document type determination system, as shown in FIG. 21, has to improve the accuracy of classification of each HTML document into one of the plurality of types by using the adjustment rules as shown in FIG. 23 when it is impossible to perform classification of each HTML document into one of the plurality of types with a high degree of accuracy by using only the structural feature rule base 420.

Japanese patent application publication No. 2000-29902 does not disclose a method of deriving both the rules, as shown in FIG. 22, stored in the structural feature rule base 420 and the adjustment rules as shown in FIG. 23 and a selection method of selecting features which can become the rules. Needless to say, in the prior art structured document type determination system, it is indispensable to construct and adjust the structural feature rule base 420 and the adjustment rules.

A problem with prior art structured document type determination systems constructed as above is thus that since it is indispensable to construct and adjust a structural feature rule base and adjustment rules, so that users have to select features which can become a base of rules and then perform tuning to set a point to be assigned to each of rules, and therefore users have to have many experiences in and knowledge of such selection and tuning and then repeat trial and error by using the experiences and knowledge to construct and adjust the structural feature rule base and adjustment rules, a lot of manpower and a lot of time are required to perform classification of each HTML document into one of a plurality of types with a high degree of accuracy.

Another problem is that prior art structured document type determination systems cannot immediately accommodate a change in a Web page provided by a World Wide Web site in the Internet. In other words, since the features of each Web page in the Internet may vary from day to day, users have to produce a rule again according to this change by repeating trial and error as in the case of creating the determination rule base for the first time while getting experiences and knowledge. For example, in a goods catalog, the following key words: “ [symbol] (Goods)”, “ [symbol] (Services), and “ [symbol] (Products)” are not used and another key word such as “ [symbol] (Products)” is widely used instead. Therefore, in this case, it is necessary to obtain information on the fact that another key word such as “ [symbol] (Products)” is widely used by using some means so as to reconstruct the structural feature rule base.

### SUMMARY OF THE INVENTION

The present invention is proposed to solve the above-mentioned problems, and it is therefore to provide a structured document type determination system for and a structured document type determination method of being able to easily create a determination rule used for determining the types of structured documents, such as Web pages, without forcedly causing users to have many experiences in and knowledge of determination of the types of structured documents, thereby immediately accommodating rapid changes in structured documents such as Web pages.

In accordance with an aspect of the present invention, there is provided a structured document type determination system including: a teacher data input unit for inputting, as teacher data, a type of each of the plurality of structured documents stored in a structured document database; a determination rule creating unit for creating a determination rule used for determining the type of each of the plurality of structured documents based on a plurality of structured documents stored in the structured document database and the teacher data; and a determination rule applying unit for determining the type of a structured document that exists on a network according to the determination rule created by the determination rule creating unit.

As a result, since the structured document type determination system according to the present invention can automatically derive an appropriate rule from a large amount of collected structured documents, the present invention offers an advantage of being able to efficiently create the determination rule.

In accordance with another aspect of the present invention, there is provided a structured document type determination method comprising the steps of: providing a list of features each of which is a measure to classify a plurality of structured document into a plurality of predetermined types and each of which is to be extracted from structured documents; by extracting a value of each of the plurality of features (referred to as a feature value) from each of a plurality of structured documents stored in a sampled structured document database according to the list of features and by inputting teacher data which is a result of determining which one of the plurality of types each of the plurality of structured documents is classified into, creating a feature value and teacher data database including the input teacher data and extracted feature values for each of the plurality of structured documents; by dividing the feature value and teacher data database into two portions, creating both a made-for-machine-learning feature value and teacher data database and a made-for-verification feature value and teacher data database; creating a determination rule used for determining which one of the plurality of types a structured document is classified into based on the made-for-machine-learning feature value and teacher data database by using a data mining tool; determining which one of the plurality of types each of a plurality of structured documents whose feature values and teacher data are stored in the made-for-verification feature value and teacher data database is classified into according to the determination rule so as to produce determination results; making an evaluation of the determination rule by comparing the determination results with the teacher data stored in the made-for-verification feature value and teacher data database; and selecting a tuning pattern from a list of tuning patterns used for tuning of the creation of the determination rule one by one so as to deliver the selected tuning pattern to the determination rule creating step, and for repeating a series of processes, such as causing the determination rule creating step to create a determination rule again according to the selected tuning pattern, causing the determining step to make a determination of the type of each of the plurality of structured documents stored in the made-for-verification feature value and teacher data database again according to the created determination rule and causing the determination rule evaluation step to make an evaluation of the created determination rule, until the determination rule creation and the evaluation are completed for all the tuning patterns in the tuning pattern list, so as to derive an optimum determination rule from among a plurality of determination rules acquired during the above processes.

Further objects and advantages of the present invention will be apparent from the following description of the preferred embodiments of the invention as illustrated in the accompanying drawings.

### BRIEF DESCRIPTION OF THE DRAWINGS

FIG. 1 is a block diagram showing the structure of a structured document type determination system according to embodiment 1 of the present invention;

FIG. 2 is a flow chart showing the operation of a feature value extraction unit of the structured document type determination system according to embodiment 1 of the present invention;

FIG. 3 is a diagram showing an example of a feature value and teacher data database of the structured document type determination system according to embodiment 1 of the present invention;

FIG. 4 is a diagram showing an example of a determination rule stored in a determination rule database of the structured document type determination system according to embodiment 1 of the present invention;

FIG. 5 is a block diagram showing the structure of a structured document type determination system according to embodiment 2 of the present invention;

FIG. 6 is a diagram showing an example of a sampled Web page database of the structured document type determination system according to embodiment 2 of the present invention;

FIG. 7 is a diagram showing an example of a Web page feature information database of the structured document type determination system according to embodiment 2 of the present invention;

FIG. 8 is a diagram showing an example of a specific site information database of the structured document type determination system according to embodiment 2 of the present invention;

FIG. 9 is a flow chart showing the operation of a feature value extraction unit of the structured document type determination system according to embodiment 2 of the present invention;

FIG. 10 is a diagram showing an example of a feature value and teacher data database of the structured document type determination system according to embodiment 2 of the present invention;

FIG. 11 is a diagram showing an example of a determination rule stored in a determination rule database of the structured document type determination system according to embodiment 2 of the present invention;

FIG. 12 is a diagram showing another example of a determination rule stored in a determination rule database of the structured document type determination system according to embodiment 2 of the present invention;

FIG. 13 is a diagram showing an example of a determination result database of the structured document type determination system according to embodiment 2 of the present invention;

FIG. 14 is a diagram showing a concrete example of a Web feature information database of the structured document type determination system according to embodiment 2 of the present invention;

FIG. 15 is a diagram showing a concrete example of a made-for-machine-learning feature value and teacher data database of the structured document type determination system according to embodiment 2 of the present invention;

FIG. 16 is a diagram showing a concrete example of a made-for-verification feature value and teacher data database of the structured document type determination system according to embodiment 2 of the present invention;

FIG. 17 is a diagram showing a concrete example of a determination rule database and a determination result database of the structured document type determination system according to embodiment 2 of the present invention;

FIG. 18 is a diagram showing a concrete example of a determination rule created by the structured document type determination system according to embodiment 2 of the present invention;

FIG. 19 is a block diagram showing the structure of a structured document type determination system according to embodiment 3 of the present invention;

FIG. 20 is a diagram showing an example of a teacher data inputter database of the structured document type judgment system according to embodiment 3 of the present invention;

FIG. 21 is a block diagram showing the structure of a prior art structured document type judgment system;

FIG. 22 is a diagram showing an example of a structural feature judgment rule base of the prior art structured document type judgment system shown in FIG. 21; and

FIG. 23 is a diagram showing an example of adjustment rules of the prior art structured document type judgment system shown in FIG. 21.

### DETAILED DESCRIPTION OF THE PREFERRED EMBODIMENTS

The invention will now be described with reference to the accompanying drawings.

Embodiment 1.

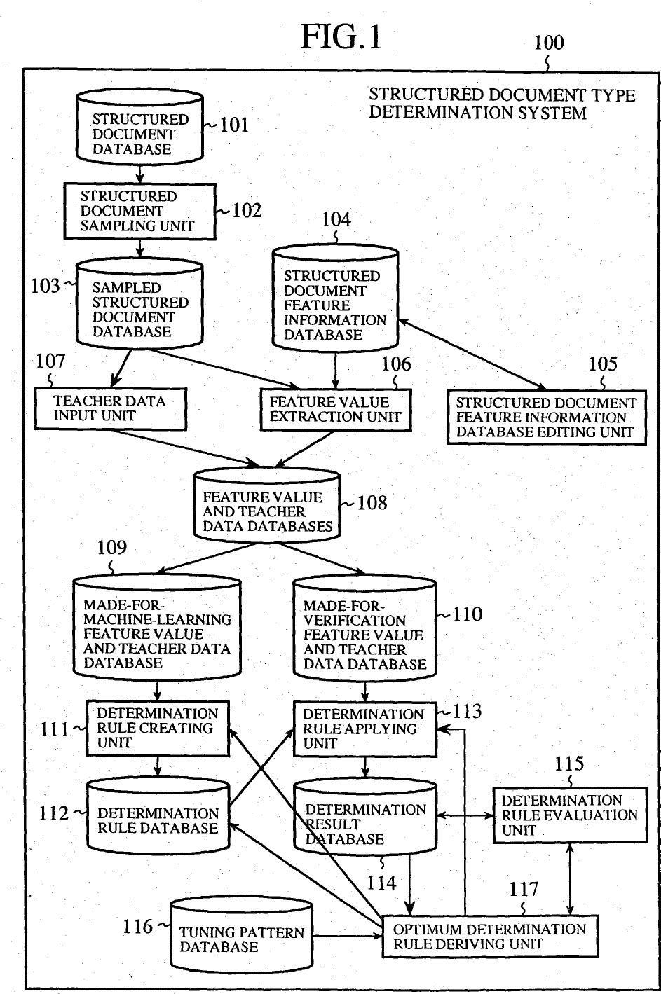

FIG. 1 is a block diagram showing the structure of a structured document type determination system according to embodiment 1 of the present invention. In the figure, reference numeral 100 denotes the structured document type determination system, reference numeral 101 denotes a structured document database for storing a plurality of structured documents written in HTML or the like, reference numeral 102 denotes a structured document sampling unit (structured document sampling means) for sampling a plurality of arbitrary structured documents from the structured document database 101, reference numeral 103 denotes a sampled structured document database for storing the plurality of structured documents sampled by the structured document sampling unit 102, reference numeral 104 denotes a structured document feature information database for storing a list of features (also referred to as explanatory variables) each of which is a measure to classify structured documents into a plurality of predetermined types and each of which is to be extracted from structured documents, reference numeral 105 denotes a structured document feature information database editing unit (structured document feature information database editing means) for editing the contents of the structured document feature information database 104, reference numeral 106 denotes a feature value extraction unit (feature value extraction means) for extracting a value of each of the plurality of features (referred to as a feature value from hereon) from each of the plurality of structured documents stored in the sampled structured document database 103 according to the list of features stored in the structured document feature information database 104, reference numeral 107 denotes a teacher data input unit (teacher data input means) for inputting a result (also referred to as teacher data) of determining which one of the plurality of types each of the plurality of structured documents stored in the sampled structured document database 103 is classified into, reference numeral 108 denotes a feature value and teacher data database for including feature values extracted by the feature value extraction unit 106 and the teacher data input by the teacher data input unit 107 for each of the plurality of structured documents stored in the sampled structured document database 103, reference numeral 109 denotes a made-for-machine-learning feature value and teacher data database including a part of the feature data and teacher data database 108, reference numeral 110 denotes a made-for-verification feature value and teacher data database including the remainder of the feature value and teacher data database 108, reference numeral 111 denotes a determination rule creating unit (determination rule creating means) for creating a determination rule used for determining which one of the plurality of types a structured document is classified into based on the made-for-machine-learning feature value and teacher data database 109, reference numeral 112 denotes a determination rule database for storing the determination rule created by the determination rule creating unit 111, reference numeral 113 denotes a determination rule applying unit (determination rule applying means) for determining which one of the plurality of types each of a plurality of structured documents whose feature values and teacher data are stored in the made-for-verification feature value and teacher data database 110 and structured documents existing on such a network as the Internet or an intranet is classified into according to the determination rule stored in the determination rule database 112, reference numeral 114 denotes a determination result database for storing determination results acquired by the determination rule applying unit 113, reference numeral 115 denotes a determination rule evaluation unit (determination rule deriving means and determination rule evaluation means) for making an evaluation of the determination rule stored in the determination rule database 112 by comparing the determination results stored in the determination result database 114 with the teacher data stored in the made-for-verification feature value and teacher data database 110, reference numeral 116 denotes a tuning pattern database (determination rule deriving means) for storing a list of tuning patterns used for tuning of the creation of the determination rule by the determination rule creating unit 111, reference numeral 117 denotes an optimum determination rule deriving unit (determination rule deriving means and optimum determination rule deriving means) for selecting a tuning pattern from the tuning pattern database 116 one by one so as to deliver the selected tuning pattern to the determination rule creating unit 111, and for repeating a series of processes, such as causing the determination rule creating unit 111 to create a determination rule again according to the selected tuning pattern, causing the determination rule applying unit 113 to make a determination of the type of each structured document stored in the made-for-machine-learning feature value and teacher data database 109 again according to the determination rule and causing the determination rule evaluation unit 115 to make an evaluation of the determination rule, until the determination rule creation and the evaluation are completed for all of the plurality of tuning patterns stored in the tuning pattern database 116, so as to derive an optimum determination rule from among a plurality of determination rules acquired during the above processes.

Next, a description will be made as to the operation of the structured document type determination system according to embodiment 1 of the present invention. Structured documents, which are targets whose types are to be determined by the structured document type determination system according to this embodiment 1, can be written in any format such as HTML or XML (extensible Markup Language). A manager (who can be a teacher data inputter who can input teacher data into the system) predetermines a plurality of types into which structured documents are to be classified, and, as described later, determines the type of each of a plurality of structured document sampled and stores the determination result in the feature value and teacher data database 108 through the teacher data input unit 107. The manager can be another person different from the teacher data inputter.

The structured document database 101 can store all structured documents collected from the network such as the Internet or an intranet. In general, structured documents can be collected from web sites on the network, such as the Internet, by a robot which is called a crawler.

The structured document sampling unit 102 samples a plurality of arbitrary structured documents from the structured document database 101, and stores those structured documents in the sampled structured document database 103. In this case, the structured document sampling unit 102 can retrieve a preset amount of structured documents from the structured document database 101 at random, or can sample a plurality of structured documents from the structured document database 101 so that they are retrieved at discrete records arranged at fixed intervals in the database and in the order that they have been stored. Furthermore, the amount of sampled structured document is determined in consideration of the accuracy of the determination rule, which will be described later, and the time required for the teacher data inputter to input a result of determination of the type of each of the plurality of sampled structured documents, i.e., teacher input data. In other words, there is a trade-off between the accuracy of the determination rule and the time required for inputting teacher data, and therefore, when the amount of sampled structured documents is large, the accuracy of the acquired determination rule is improved while the load of inputting teacher data increases. For example, the amount of structured documents sampled by the structured document sampling unit 102 can be about several percents of the plurality of structured documents stored in the structured document database 101.

The structured document feature information database 104 stores a list of features each of which is a measure to classify structured documents into the plurality of predetermined types and each of which is to be extracted from structured documents. The list of features includes features associated with tags, attributes, the values of attributes, URLs, character strings, and so on, which can be included in each of all elements defined by a descriptive language such as HTML in which structured documents are written, and can be anything that becomes a measure to classify structured documents into the plurality of predetermined types. In other words, the list of features covers features that can become a measure to classify structured documents into the plurality of predetermined types.

For example, in the case where structured documents are Web pages written in HTML, the list of features includes the number of use of each of all tags which can be used in structured documents, the number of use of each of all tags that includes each of all attributes which can be provided for each tag, and so on. Although even in the case where structured documents are Web pages written in XML the list of features includes the number of use of each of all tags which can be used in structured documents, the number of use of each of all tags that includes each of all attributes which can be provided for each tag, and so on, it is preferable that in the case of XML the list of features also includes features associated with tags defined by common DTDs (Document Type Definitions) created for various fields because tag names and attributes can be freely defined using DTDs. In either of these two cases, each feature, i.e., explanatory variable stored in the structured document feature information database 104 is a measure to determine which one of the plurality of predetermined types each structured document is classified into, and the type of each structured document is determined according to one or more feature values, i.e., the values of one or more explanation variables included in the list of features, as described later. A data mining tool is used as the determination rule creating unit 111, as described later. Therefore, even if the structured document feature information database 104 includes features unnecessary for determination of the types of structured documents, they present no problem because they are not used as the determination rule.

The manager can perform editing such as changing the contents of the structured document feature information database 104, making an addition to the contents of the structured document feature information database 104, and deleting one or more items from the contents of the structured document feature information database 104 through the structured document feature database editing unit 105. Preferably, the structured document feature information database 104 can include a default list of features. The manager can edit the default list of features if necessary.

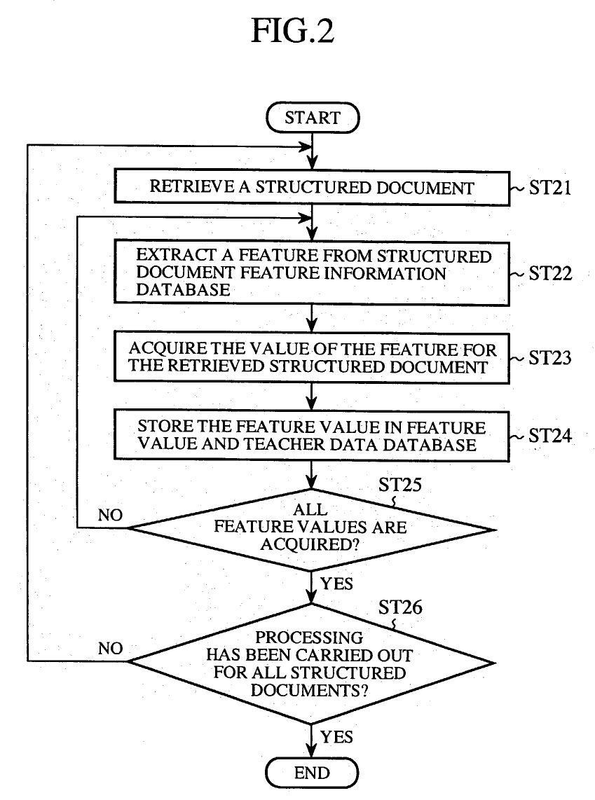

FIG. 2 is a flow chart showing the operation of the feature value extraction unit 106. The feature value extraction unit 106, instep ST21, retrieves each of the plurality of structured documents stored in the sampled structured document database 103 one by one, in step ST22, further extracts (or selects) each of the plurality of features stored in the structured document feature information database 104, in step ST23, acquires the value of each of the plurality of features extracted in step ST22 for each structured document retrieved, and, in step ST24, stores the value in a corresponding item of the feature value and teacher data database 108, which is provided for each of the plurality of structured documents retrieved from the sampled structured document database 103. The feature value extraction unit 106 then, in step ST25, checks whether it has acquired the value of each of all the features included in the list stored in the structured document feature information database 104, and, if there is still one or more features whose values have not been acquired yet, returns to step ST22 in which the feature value extraction unit 106 extracts one of remaining features whose values have not been acquired yet and acquires its value. On the other hand, the feature value extraction unit 106, in step ST26, determines whether it has completed the acquisition of feature values, i.e., explanation variable values for all the structured documents stored in the sampled structured document database 103 when determined that the acquisition of all the feature values for the structured document selected in step ST21 is completed in step ST25. If there is still one or more structured documents whose features values have not been acquired yet, the feature value extraction unit 106 returns to step ST21 in which it retrieves one of remaining structured documents whose features values have not been acquired yet, and then repeats the above-mentioned processes in steps ST22 to S25 for this retrieved structured document. On the other hand, the feature value extraction unit 106 ends the extraction process of extracting feature values when determined that the acquisition of all the feature values for all the structured documents stored in the sampled structured document database 103 is completed in step ST26.

The teacher data input unit 107 enables the teacher data inputter to classify each of the plurality of structured documents stored in the sampled structured document database 103 into one of the plurality of predetermined types by displaying each structured document on a display unit (not shown in the figure). In other words, the teacher data inputter is allowed to determine the type (type 1, type 2, or the like) of each of the plurality of structured documents stored in the sampled structured document database 103 by seeing each structured document displayed on a display and to input teacher data which is the determination result. The teacher data input unit 107 stores this input teacher data in a corresponding item provided for each structured document within the feature value and teacher data database 108.

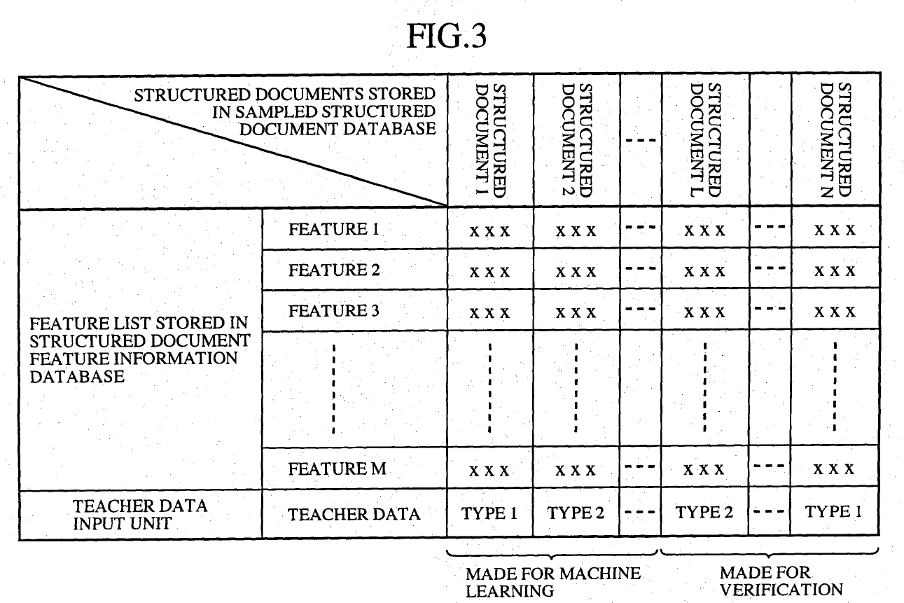

FIG. 3 is a diagram showing an example of the feature value and teacher data database 108. For the sake of simplicity, feature values acquired by the feature value extraction unit 106 and teacher data input by the teacher data input unit 107 are separately illustrated. As shown in FIG. 3, for each of all structured documents (structured documents numbered 1 through N) stored in the sampled structured document database 103, the feature value and teacher data database 108 stores the values of all features (features numbered 1 through M) listed in the list stored in the structured document feature information database 104, and teacher data which is the determination result input by the teacher data inputter.

The structured document type determination system 100 creates the made-for-machine-learning feature value and teacher data database 109 and the made-for-verification feature value and teacher data database 110 by dividing the feature value and teacher data database 108 into the two portions, as shown in FIG. 3. In this case, the structured document type determination system 100 can divide the feature value and teacher data database 108 into two equal portions or two portions which are almost equal in size. As an alternative, the structured document type determination system 100 can extract a plurality of data sets from all the data sets included in the feature value and teacher data database 108 at random so as to create the made-for-machine-learning feature value and teacher data database 109 and to create the made-for-verification feature value and teacher data database 110 from the remaining data sets. Anyway, the structured document type determination system 100 creates the made-for-machine-learning feature value and teacher data database 109 and the made-for-verification feature value and teacher data database 110 by dividing the feature value and teacher data database 108 by using a specific method.

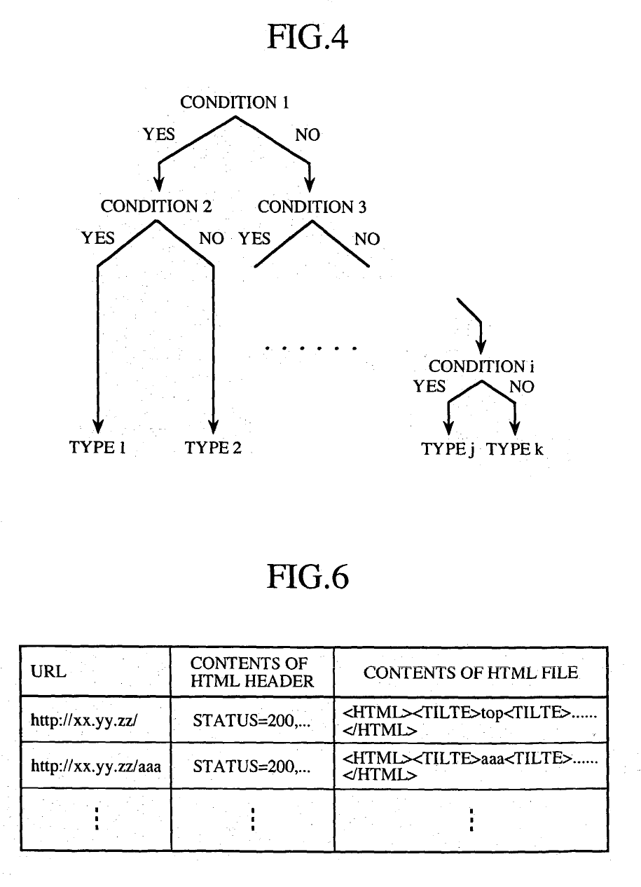

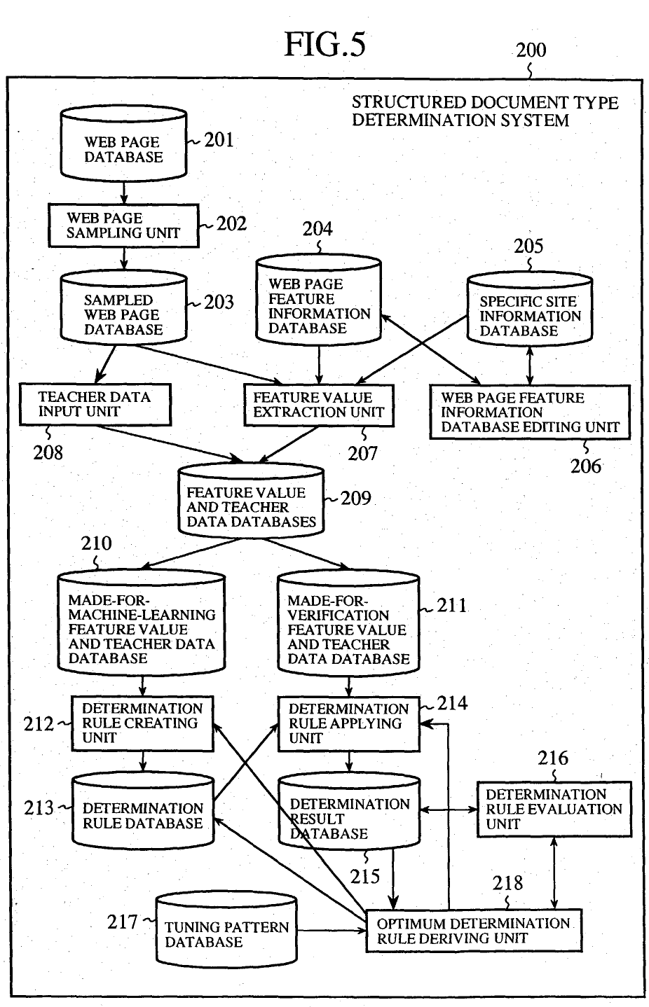

The determination rule creating unit 111 creates a determination rule used for determining which one of the plurality of predetermined types each structured document is classified into based on the made-for-machine-learning feature value and teacher data database 109, and stores the created determination rule in the determination rule database 112. For example, the determination rule creating unit 111 performs data mining on the made-for-machine-learning feature value and teacher data database 109 by using a data mining tool using decision trees, such as a commercially available data mining tool, which is a machine learning technique, so as to create a determination rule as shown in FIG. 4, and stores it in the determination rule database 112. FIG. 4 shows an example of the determination rule using a decision tree. In this example, the decision tree includes a condition 1 as the uppermost node and conditions 2 to i as child nodes, and structured documents are classified into a plurality of types 1 to k according to the plurality of conditions.

The determination rule applying unit 113 applies the determination rule stored in the determination rule database 112 to each of the plurality of structured documents stored in the made-for-verification feature value and teacher data database 110 so as to determines the type of each of the plurality of structured documents. The determination rule applying unit 113 then stores the determination result in the determination result database 114. At that time, for each of the plurality of structured documents stored in the made-for-verification feature value and teacher data database 110, the determination rule applying unit 113 stores the teacher data which is the determination result input by the teacher data inputter through the teacher data input unit 107 in the determination result database 114 while associating the teacher data with the determination result acquired thereby.

The determination rule evaluation unit 115 makes an evaluation of the accuracy of the determination rule stored in the determination rule database 112 based on the determination result database 114 and stores the evaluation result in the determination result database 114. The determination rule evaluation unit 115 can make an evaluation of the determination rule according to the difference between the teacher data which is the determination result input by the teacher data inputter through the teacher data input unit 107 and the determination result obtained by the determination rule applying unit 113 according to the determination rule. For example, the determination rule evaluation unit 115 can make an evaluation of the accuracy of the determination rule based on a repeatability ratio which is the ratio of the number of structured documents that are determined to be of a certain type according to the determination rule stored in the determination rule database 112 to the number of structured documents that are determined to be of the certain type by the teacher data inputter. As an alternative, the determination rule evaluation unit 115 can make an evaluation of the accuracy of the determination rule based on a matching ratio which is the ratio of the number of structured documents that are determined to be of a certain type by the teacher data inputter to the number of structured documents that are determined to be of the certain type according to the determination rule stored in the determination rule database 112. As an alternative, the determination rule evaluation unit 115 can make an evaluation of the accuracy of the determination rule by using a combination of the repeatability ratio and the matching ratio. The evaluation method is not limited to either of the above-mentioned ones, and can be anything for enabling an evaluation of the accuracy of the determination rule.

The optimum determination rule deriving unit 117 selects a tuning pattern from the tuning pattern database 116 one by one, and then delivers it to the determination rule creating unit 111. For example, tuning patterns are predetermined conditions such as “Every structured document of type 1 can be erroneously determined to be of type 2, whereas every structured document of type 2 cannot be erroneously determined to be of type 1”. As a result, the determination rule creating unit 111 creates a determination rule again according to the selected tuning pattern and stores the determination rule in the determination rule database 112, and the determination rule applying unit 113 applies this determination rule to each of the plurality of structured documents stored in the made-for-verification feature value and teacher data database 110 so as to determine the type of each of the plurality of structured documents again. The determination rule applying unit 113 then stores the determination result in the determination result database 114. In addition, the determination rule evaluation unit 115 makes an evaluation of the accuracy of the new determination rule, which is created again based on the new determination results stored in the determination result database 114 and is stored in the determination rule database 112, and then stores the evaluation result (i.e., a measure showing the evaluation, such as the repeatability ratio, the matching ratio, or the combination of them) in the determination result database 114.

The optimum determination rule deriving unit 117 repeats the series of such processes until the creating of determination rules for all the tuning parameters stored in the tuning parameter database 116 is completed, and derives an optimum determination rule and then stores this optimum determination rule in the determination rule database 112 as a current optimum determination rule. At that time, the optimum determination rule deriving unit 117 determines, as the optimum determination rule, the determination rule having the highest measure (e.g., the repeatability ratio, the matching ratio, or the combination of them which shows the evaluation of the determination rule acquired by the determination rule evaluation unit 115).

After deriving the optimum determination rule, the determination rule applying unit 113 can determine the type of a structured document that exists on the network according to the optimum determination rule. The determination rule applying unit 113 can also determine the type of any structured document stored in the structured document database 101 that stores structured documents collected by way of the network, and can access an arbitrary structured document that exists on the network so as to determine the type of the structured document.

As mentioned above, in accordance with embodiment 1 of the present invention, since the structured document type determination system can efficiently derive an optimum determination rule from a large amount of structured documents collected using a crawl or the like based on the list of features which is disposed in advance, the present embodiment offers an advantage of being able to negate the need to use a trial-and-error method for creating a determination rule. Furthermore, since the structured document type determination system according to this embodiment 1 can derive the optimum determination rule whenever new structured documents are collected using a crawl or the like and the contents of the structured document database 101 are updated, the structured document type determination system can promptly accommodate any change in each structured document stored in the structured document database 101.

In addition, when a new feature is added to each structured document or a new feature is discovered in each structured document, since the manager can create a new optimum determination rule by taking the value of the new feature into consideration by only adding the new feature to the structured document feature information database 104 through the structured document feature information database editing unit 105, the present embodiment offers an advantage of being able to negate the need to use a trial-and-error method for creating a determination rule even in this case.

Embodiment 2.

FIG. 5 is a block diagram showing the structure of a structured document type determination system according to embodiment 2 of the present invention. In the figure, reference numeral 200 denotes the structured document type determination system, reference numeral 201 denotes a Web page database (structured document database) for storing a plurality of Web pages written in HTML or the like, reference numeral 202 denotes a Web page sampling unit (structured document sampling means) for sampling a plurality of arbitrary Web pages from the Web page database 201, reference numeral 203 denotes a sampled Web page database for storing the plurality of Web pages sampled by the Web page sampling unit 202, reference numeral 204 denotes a Web page feature information database for storing a list of features each of which is a measure to classify Web pages into a plurality of predetermined types and each of which is to be extracted from Web pages, reference numeral 205 denotes a specific site information database for storing URLs of specific web sites, reference numeral 206 denotes a Web page feature information database editing unit (structured document feature information database editing means) for editing the contents of the Web page feature information database 204, reference numeral 207 denotes a feature value extraction unit (feature value extraction means) for extracting a plurality of feature values from each of the plurality of structured documents stored in the sampled Web page database 203 according to the list of features stored in the Web page feature information database 204, reference numeral 208 denotes a teacher data input unit (teacher data input means) for inputting a result of determining which one of the plurality of types each of the plurality of Web pages stored in the sampled Web page database 203 is classified into, reference numeral 209 denotes a feature value and teacher data database including the plurality of feature values extracted by the feature value extraction unit 207 and the teacher data input by the teacher data input unit 208 for each of the plurality of Web pages stored in the sampled Web page database 203, reference numeral 210 denotes a made-for-machine-learning feature value and teacher data database including a part of the feature data and teacher data database 209, reference numeral 211 denotes a made-for-verification feature value and teacher data database including the remainder of the feature value and teacher data database 209, reference numeral 212 denotes a determination rule creating unit (determination rule creating means) for creating a determination rule used for determining which one of the plurality of types a Web page is classified into based on the made-for-machine-learning feature value and teacher data database 210, reference numeral 213 denotes a determination rule database for storing the determination rule created by the determination rule creating unit 212, reference numeral 214 denotes a determination rule applying unit (determination rule applying means) for determining which one of the plurality of types each of a plurality of Web pages whose feature values and teacher data are stored in the made-for-verification feature value and teacher data database 211 and Web pages existing on such a network as the Internet or an intranet is classified into according to the determination rule stored in the determination rule database 213, reference numeral 215 denotes a determination result database for storing determination results acquired by the determination rule applying unit 214, reference numeral 216 denotes a determination rule evaluation unit (determination rule deriving means and determination rule evaluation means) for making a evaluation of the determination rule stored in the determination rule database 213 by comparing the determination results stored in the determination result database 215 with the teacher data stored in the made-for-verification feature value and teacher data database 211, reference numeral 217 denotes a tuning pattern database (determination rule deriving means) for storing a list of tuning patterns used for tuning of the creation of the determination rule by the determination rule creating unit 212, and reference numeral 218 denotes an optimum determination rule deriving unit (determination rule deriving means and optimum determination rule deriving means) for selecting a tuning pattern from the tuning pattern database 217 one by one so as to deliver the selected tuning pattern to the determination rule creating unit 212, and for repeating a series of processes, such as causing the determination rule creating unit 212 to create a determination rule again according to the selected tuning pattern, causing the determination rule applying unit 214 to make a determination of the type of each Web page stored in the made-for-machine-learning feature value and teacher data database 210 again according to the determination rule and causing the determination rule evaluation unit 216 to make an evaluation of the determination rule, until the determination rule creation and the evaluation are completed for all of the plurality of tuning patterns stored in the tuning pattern database 217, so as to derive an optimum determination rule from among a plurality of determination rules acquired during the above processes.

Next, a description will be made as to the operation of the structured document type determination system according to embodiment 2 of the present invention. The structured document type determination system according to this embodiment 2 is a system for determining the type of a Web page. A Web page, which is the target whose type is to be determined by the structured document type determination system, can be written in any format such as HTML or XML. It is well known that Web pages provided for various fields exist on the network such as the Internet or an intranet. Additionally, Web pages intended for portable terminals, such as NTT DoCoMo's i-mode (registered trademark) mobile phones, au's EZweb (registered trademark) mobile phones, exist on the Internet, in addition to Web pages intended for personal computers (PCs). Searching promptly and properly for a target Web page through such a large amount of Web pages is a important technical issue. The structured document type determination system according to embodiment 2 of the present invention is suitable for such a Web page search.

A manager can predetermine a plurality of types into which Web pages are to be classified. For example, the manager can define, as the plurality of types, a Web page type intended for PCs, a Web page type intended for i-mode (registered trademark) mobile phones, and a Web page type intended for Ezweb (registered trademark) mobile phones. i-mode (registered trademark) uses, as a descriptive language used for creating Web pages, HTML intended for i-mode (registered trademark) including special i-mode-only tags, which implement original functions, in addition to cHTML (compact HTML), whereas EZweb (registered trademark) uses, as a descriptive language used for creating Web pages, HDML(Handheld Device Markup Language) incompatible with HTML. Of course, the plurality of predetermined types are not limited to the Web page type intended for PCs, the Web page type intended for i-mode (registered trademark) mobile phones, and the Web page type intended for EZweb (registered trademark) mobile phones, and can include Web page types intended for other portable terminals such as a Web page type intended for J-sky mobile phones. As an alternative, the manager can define, as the plurality of types, news, message boards, and other Web page types.

The Web page database 201 can store all Web pages collected from the network such as the Internet or an intranet. In general, Web pages are collected from Web sites on the network, such as the Internet, by a robot which is called a crawler.

The Web page sampling unit 202 samples a plurality of arbitrary Web pages from the Web page database 201, and stores those Web pages in the sampled Web page database 203. In this case, the Web page sampling unit 202 can retrieve a preset amount of Web pages from the Web page database 201 at random, or can sample a plurality of Web pages from the Web page database 201 so that they are retrieved at discrete records arranged at fixed intervals in the database and in the order that they have been stored. Furthermore, the amount of sampled Web pages is determined in consideration of the accuracy of the determination rule, which will be described later, and the time required for a teacher data inputter to input a result of determination of the type of each of the plurality of sampled Web pages. In other words, there is a trade-off between the accuracy of the determination rule and the time required for inputting teacher data, and therefore, when the amount of sampled Web pages is large, the accuracy of the acquired determination rule is improved while the load of inputting teacher data increases. For example, the amount of Web pages sampled by the Web page sampling unit 202 can be about several percents of the plurality of Web pages stored in the Web page database 201.

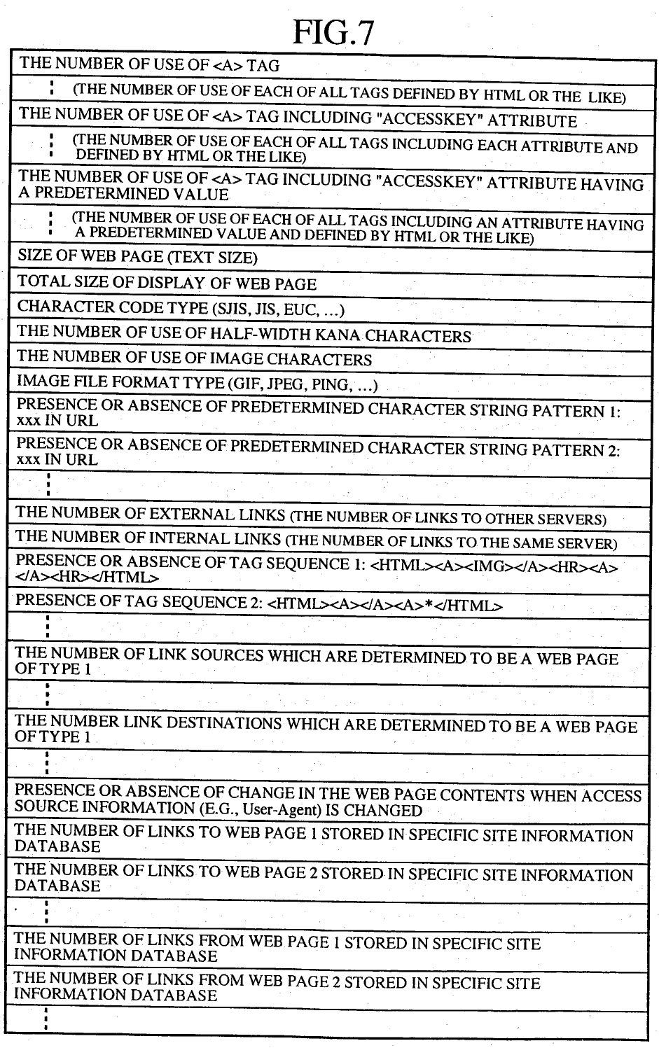

The Web page feature information database 204 stores a list of features, as shown in FIG. 7, each of which is a measure to classify Web pages into the plurality of predetermined types and each of which is to be extracted from Web pages. The list of features of FIG. 7 including the following pieces of information:

(1) The number of use of each of all tags defined by HTML or the like

(2) The number of use of each of all tags including each attribute and defined by HTML or the like

For example, in the case of an <A> tag having an attribute, such as ACCESSKEY or HREF, the number of use of an <A> tag including ACCESSKEY attribute, the number of use of an <A> tag including HREF attribute, and so on are listed.

(3) The number of use of each of all tags including an attribute having a predetermined value and defined by HTML or the like

When an attribute of a tag can have a continuous value, a maximum of the continuous value, a minimum of the continuous value, or an average of the continuous value can be set as the predetermined value of the attribute. In contrast, when an attribute of a tag can have a discrete value, each element of a set, such as a set of numerical values (0,1, . . . ,9), a set of signs (*,#, . . . ), or a set of alphabets (A,B, . . . ), can be set as the predetermined value of the attribute.

(4) The text size of each Web page

(5) The total size of display of each Web page

The total size is a sum of the sizes of pages (e.g., image files) quoted by the SRC attribute of an <IMG> tag, the DATA attribute of an <OBJECT> tag, and so on.

(6) Character code type (SJIS, JIS, EUC, . . . )

(7) The number of use of half-width kana characters

(8) The number of use of image characters (“emoji”)

(9) Image file format type (GIF, JPEG, PING, . . . )

(10) Presence or absence of each predetermined character string pattern included in the URL of each Web page

(11) The length of the URL of each Web page

(12) The extension of the URL of each Web page

(13) The number of external links (number of links to other servers)

(14) The number of internal links (number of links to the same server as the Web server that provides the Web page in question)

(15) Presence or absence of each predetermined tag sequence

The manager can derive a tag sequence from each specific sampled Web page according to the plurality of predetermined types by using a data mining tool, and can set it as a predetermined tag sequence. As an alternative, the manager can derive the predetermined tag sequences by himself or herself.

(16) The number of link sources which are determined to be each Web page type

(17) The number of link destinations which are determined to be each Web page type

(18) Presence or absence of change in the contents of each Web page when access source information (e.g., User-Agent) is changed

(19) The number of links to each Web page (e.g., a Web page of a certain type) stored in the specific site information database 205

(20) The number of links from each Web page (e.g., a Web page of a certain type) stored in the specific site information database 205

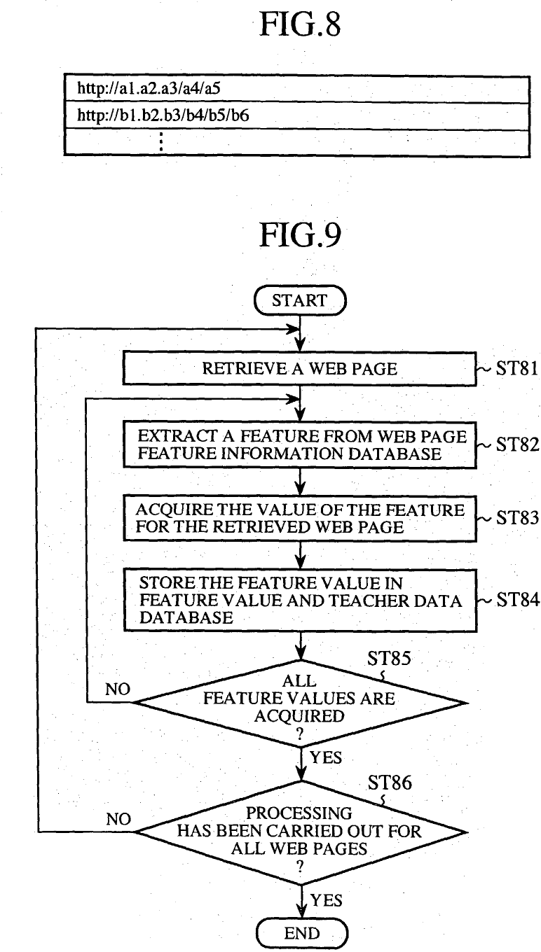

The specific site information database 205 stores a list of URLs of Web pages, as shown in the FIG. 8, which can be defined by the manager. For example, when the manager can define, as the plurality of types, a Web page type intended for PCs, a Web page type intended for i-mode (registered trademark) mobile phones, and a Web page type_intended for EZweb (registered trademark) mobile phones, the manager can allow the structured document type determination system to easily determine whether or not each Web page is a Web page intended for i-mode (registered trademark) mobile phones according to the number of links as listed in the above-mentioned items (19) and (20) by writing the URLs of Web pages which are determined to be Web pages intended for i-mode (registered trademark) mobile phones in the specific site information database 205.

FIG. 9 is a flow chart showing the operation of the feature value extraction unit 207. The feature value extraction unit 207, in step ST81, retrieves each of the plurality of Web pages stored in the sampled Web page database 203 one by one, further, in step ST82, extracts each of the plurality of features stored in the Web page feature information database 204, in step ST83, acquires the value of each of the plurality of features extracted in step ST82 for each Web page retrieved, and then, in step ST84, stores the value in a corresponding item of the feature value and teacher data database 209, which is provided for each Web page retrieved. The feature value extraction unit 207 then, in step ST85, checks whether it has acquired the value of each of all the features included in the list stored in the Web page feature information database 204, and, if there is still one or more features whose values have not been acquired yet, returns to step ST82 in which the feature value extraction unit 207 extracts one of remaining features whose values have not been acquired yet and acquires its value. On the other hand, the feature value extraction unit 207, in step ST86, determines whether it has completed the acquisition of feature values, i.e., explanation variable values for all the Web pages stored in the sampled Web page database 203 when determined that the acquisition of all the feature values for the Web page selected in step ST81 is completed in step ST85. If there is still one or more Web pages whose features values have not been acquired yet, the feature value extraction unit 207 returns to step ST81 in which it retrieves one of remaining Web pages whose features values have not been acquired yet, and then repeats the processes in steps ST82 to S85 for this retrieved Web page. On the other hand, the feature value extraction unit 207 ends the extraction process of extracting feature values when determined that the acquisition of all the feature values for all the Web pages stored in the sampled Web page database 203 is completed in step ST86.

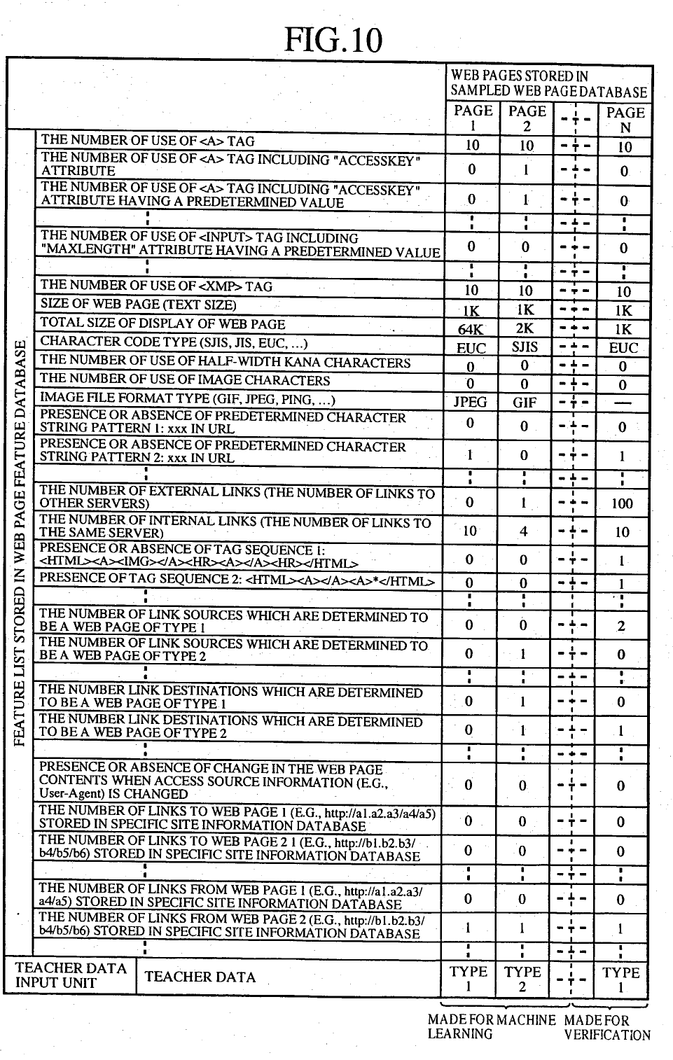

FIG. 10 is a diagram showing an example of the feature value and teacher data database 209. For the sake of simplicity, feature values, i.e., explanation variable values acquired by the feature value extraction unit 207 and teacher data input by the teacher data input unit 208 are separately illustrated. As shown in FIG. 10, for each of all the Web pages (Web pages numbered 1 through N) stored in the sampled Web page database 203, the feature value and teacher data database 209 stores the values of all the features (features numbered 1 through M), i.e., explanation variable values listed in the list stored in the Web page feature information database 204, and teacher data which is the determination result input by the teacher data inputter.

The structured document type determination system 200 creates the made-for-machine-learning feature value and teacher data database 210 and the made-for-verification feature value and teacher data database 211 by dividing the feature value and teacher data database 209 into the two portions, as shown in FIG. 10. In this case, the structured document type determination system 200 can divide the feature value and teacher data database 209 into two equal portions or two portions which are almost equal in size. As an alternative, the structured document type determination system 200 can extract a plurality of data sets from all the data sets included in the feature value and teacher data database 209 at random so as to create the made-for-machine-learning feature value and teacher data database 210 and to create the made-for-verification feature value and teacher data database 211 from the remaining data sets. Anyway, the structured document type determination system 200 creates the made-for-machine learning feature value and teacher data database 210 and the made-for-verification feature value and teacher data database 211 by dividing the feature value and teacher data database 209 by using a specific method.

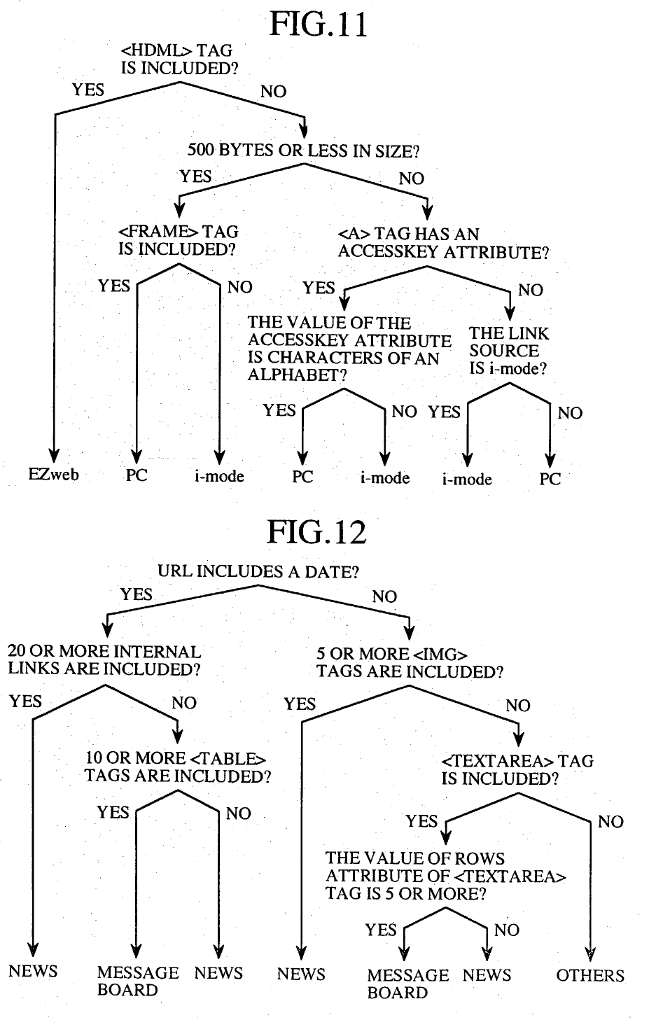

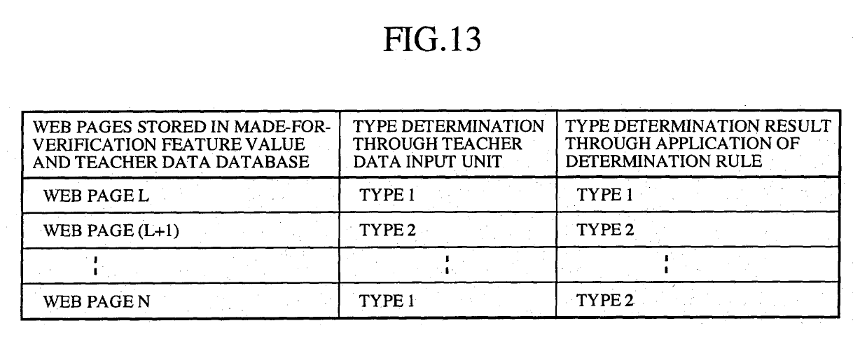

The determination rule creating unit 212 creates a determination rule used for determining which one of the plurality of predetermined types a Web page is classified into based on the made-for-machine-learning feature value and teacher data database 210, and stores the created determination rule in the determination rule database 213. For example, the determination rule creating unit 212 performs data mining on the made-for-machine-learning feature value and teacher data database 210 by using a data mining tool, such as a commercially available data mining tool, which is a machine learning technique, so as to create a determination rule as shown in FIGS. 11 or 12, and stores it in the determination rule database 213. FIG. 11 shows an example of the determination rule using a decision tree when the plurality of predetermined types are a Web page type intended for i-mode (registered trademark) mobile phones, a Web page type intended for EZweb (registered trademark) mobile phone, and a Web page type intended for PCs. The uppermost node of this decision tree is “Whether or not an <HDML> tag is included?”. As previously mentioned, since Web pages intended for EZweb (registered trademark) mobile phones are written in HDML incompatible with HTML and compactHTML, a Web page including an <HDML> tag can be determined to be a Web page intended for EZweb (registered trademark) mobile phones. If “No” in the uppermost node, the decision tree advances to a child node: “Whether or not the Web page size is 500 bytes or less?”. The node: “Whether or not the Web page size is 500 bytes or less?” includes two child nodes: “Whether or not a <FRAME> tag is included?” and “Whether or not an <A> tag includes ACCESSKEY attribute?”. The decision tree advances to the first child node: “Whether or not a <FRAME> tag is included?” when the Web page size is 500 bytes or less, whereas the decision tree advances to the second child node: “Whether or not an <A>tag includes ACCESSKEY attribute?” when the Web page size exceeds 500 bytes. In the former case, it is then determined that the Web page in question is a Web page intended for PCs if it includes a <FRAME> tag, whereas it is determined that the Web page in question is a Web page intended for i-mode (registered trademark) mobile phones if it does not include any <FRAME> tag.

On the other hand, in the latter case, the node: “Whether or not an <A> tag includes an ACCESSKEY attribute?” further has two child nodes: “Whether or not the value of the ACCESSKEY attribute is characters of an alphabet?” and “Whether or not the link source is an i-mode (registered trademark) Web page?”. The decision tree advances to the child node: “Whether or not the value of the ACCESSKEY attribute is characters of an alphabet?” when the <A> tag includes an ACCESSKEY attribute, whereas the decision tree advances to the other child node of “Whether or not the link source is an i-mode (registered trademark) Web page?” when the <A> tag does not include any ACCESSKEY attribute. In the former case, it is determined that the Web page in question is a Web page intended for PCs if the value of the ACCESSKEY attribute is characters of an alphabet, and, otherwise, it is determined that the Web page in question is a Web page intended for i-mode (registered trademark) mobile phones. On the other hand, in the latter case, it is determined that the Web page in question is a Web page intended for i-mode (registered trademark) mobile phones if the link source is an i-mode (registered trademark) Web page, and, otherwise, it is determined that the Web page in question is a Web page intended for PCs.

FIG. 12 shows another example of the determination rule using a decision tree. In the example of the determination rule using a decision tree, the plurality of predetermined types are set to news, message boards, and other Web page types. The uppermost node of this decision tree is “Whether or not the URL includes a date?”. This node is based on the fact that a Web page whose URL includes a date is assumed to be a news site's Web page or a message board site's Web page. In this case, the Web page feature information database 204 includes “Presence or absence of a date in the URL” as an explanation variable.

The node: “Whether or not the URL includes a date?” includes two child nodes: “Whether or not 20 or more internal links are included?” and “Whether or not 5 or more <IMG> tags are included?”. The decision tree advances to the child node: “Whether or not 20 or more internal links are included?” when the URL contains a date, and, otherwise, advances to the other child node: “Whether or not 5 or more <IMG> tags are included?”. Then, in the former case, it is determined that the Web page in question is a news site's Web page if it includes 20 or more internal links. In contrast, if the Web page in question does not include 20 or more internal links, the decision tree advances to a child node: “Whether or not 10 or more <TABLE> tags are included?”. It is determined that the Web page in question is a message board site's Web page if it includes 10 or more <TABLE> tags, and, otherwise, it is determined that the Web page in question is a news site's Web page.

On the other hand, when “No” in the uppermost node and the decision tree then advances to the child node: “Whether or not 5 or more <IMG> tags are included?”, it is determined that the Web page in question is a news site's Web page if it includes 5 or more <IMG> tags. In contrast, the decision tree advances to the child node: “Whether or not a <TEXTAREA> tag is included?” if not. When the Web page in question includes a <TEXTAREA> tag, the decision tree further advances to the child node: “Whether or not the value of the ROWS attribute of the <TEXTAREA> tag is 5 or more?”. In contrast, when the Web page in question does not include any <TEXTAREA> tag, it is determined that the Web page in question is a Web page of another type. On the other hand, it is determined that the Web page in question is a news sites Web page if “YES” in the child node: “Whether or not the value of the ROWS attribute of the <TEXTAREA> tag is 5 or more?”. In contrast, if “No” in the child node: “Whether or not the value of the ROWS attribute of the <TEXTAREA> tag is 5 or more?”, it is determined that the Web page in question is a message board site's Web page.

FIG. 11 and FIG. 12 are examples of the decision tree stored in the determination rule database 213, and the determination rule acquired by the structured document type determination system according to this embodiment 2 is not limited to either of those examples.

The determination rule applying unit 214 applies the determination rule stored in the determination rule database 214 to each of the plurality of Web pages stored in the made-for-verification feature value and teacher data database 211 so as to determine the type of each of the plurality of Web pages. The determination rule applying unit 214 then stores the determination result in the determination result database 215. At that time, for each of the plurality of Web pages stored in the made-for-verification feature value and teacher data database 211, the determination rule applying unit 214 stores the teacher data which is the determination result input by the teacher data inputter through the teacher data input unit 208 in the determination result database 215 while associating the teacher data with the determination result acquired thereby.

The determination rule evaluation unit 216 makes an evaluation of the accuracy of the determination rule stored in the determination rule database 213 based on the determination result database 215 and stores an evaluation result in the determination result database 215. The determination rule evaluation unit 216 can make an evaluation of the determination rule according to the difference between the teacher data which is the determination result input by the teacher data inputter through the teacher data input unit 208 and the determination result obtained by determination rule applying unit 214 according to the determination rule. For example, the determination rule evaluation unit 216 can make an evaluation of the accuracy of the determination rule based on a repeatability ratio which is the ratio of the number of Web pages that are determined to be of a certain type according to the determination rule stored in the determination rule database 213 to the number of Web pages that are determined to be of the certain type by the teacher data inputter. As an alternative, the determination rule evaluation unit 216 can make an evaluation of the accuracy of the determination rule based on a matching ratio which is the ratio of the number of Web pages that are determined to be of a certain type by the teacher data inputter to the number of Web pages that are determined to be of the certain type according to the determination rule stored in the determination rule database 213. As an alternative, the determination rule evaluation unit 216 can make an evaluation of the accuracy of the determination rule by using a combination of the repeatability ratio and the matching ratio. The evaluation method is not limited to either of the above-mentioned ones, and can be anything for enabling an evaluation of the accuracy of the determination rule.

The optimum determination rule deriving unit 218 selects a tuning pattern from the tuning pattern database 217 one by one, and then delivers it to the determination rule creating unit 212. For example, tuning patterns are predetermined conditions such as “Every structured document of type 1 can be erroneously determined to be of type 2, whereas every structured document of type 2 cannot be erroneously determined to be of type 1”. As a result, the determination rule creating unit 212 creates a determination rule again according to the selected tuning pattern and stores the determination rule in the determination rule database 213, and the determination rule applying unit 214 applies this determination rule to each of the plurality of Web pages stored in the made-for-verification feature value and teacher data database 211 so as to determine the type of each of the plurality of Web pages again. The determination rule applying unit 214 then stores the determination result in the determination result database 215. In addition, the determination rule evaluation unit 216 makes an evaluation of the accuracy of the new determination rule, which is created again based on the new determination results stored in the determination result database 215 and which is stored in the determination rule database 213, and then stores an evaluation result (i.e., a measure showing the evaluation, such as the repeatability ratio, the matching ratio, or the combination of them) in the determination result database 215.

The optimum determination rule deriving unit 218 repeats the series of such processes until the creating of determination rules for all the tuning parameters stored in the tuning parameter database 217 is completed, and derives an optimum determination rule and then stores this optimum determination rule in the determination rule database 213 as a current optimum determination rule. At that time, the optimum determination rule deriving unit 218 determines, as the optimum determination rule, the determination rule having the highest measure (e.g., the repeatability ratio, the matching ratio, or the combination of them), the measure showing the evaluation of the determination rule acquired by the determination rule evaluation unit 216.

After deriving the optimum determination rule, the determination rule applying unit 214 can determine the type of a Web page that exists on the network according to the optimum determination rule. The determination rule applying unit 214 can also determine the type of any Web page stored in the Web page database 201 which stores Web pages collected by way of the network, and can access an arbitrary Web page that exists on the network so as to determine the type of the Web page.

As previously mentioned, the determination rule creating unit 212 performs data mining on the made-for-machine-learning feature value and teacher data database 210 by using a data mining tool such as a commercially available data mining tool so as to create a determination rule. See5/C5.0 provided by RuleQuest Research Pty Ltd. (http://www.rulequest.com/) is a typical commercially available data mining tool. A concrete example of creating a determination rule by using this data mining tool will be explained in the following.

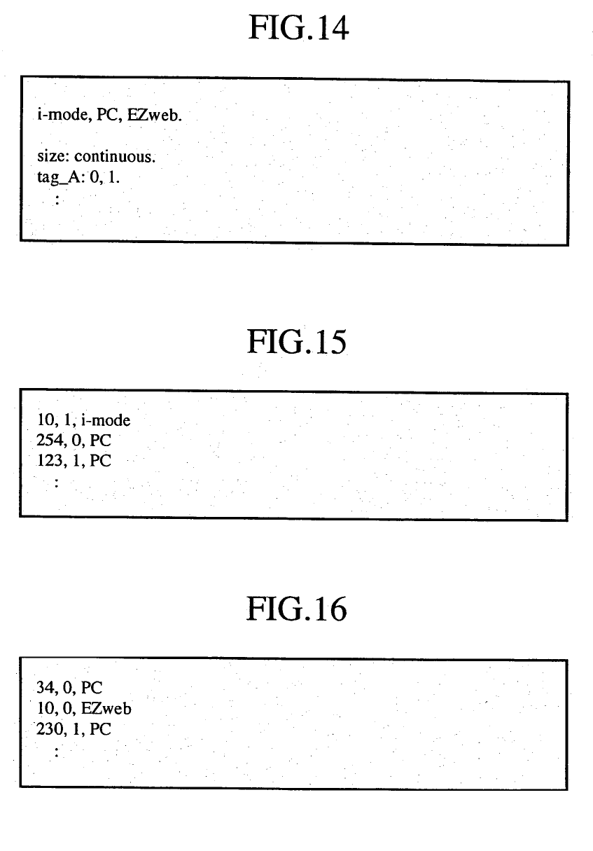

In the case of using the data mining tool See5/C5.0, the Web page feature information database 204 consists of a names file (file extension is “names”) as shown in FIG. 14, the made-for-machine-learning feature value and teacher data database 210 consists of a data file (file extension is “data”) as shown in FIG. 15, and the made-for-verification feature value and teacher data database 211 consists of a cases file (file extension is “cases”) as shown in FIG. 16. When the name of data which is the target whose Web page type is to be determined is set to “HANTEI” (referred to as application name in the data mining tool See5/C5.0), FIGS. 14 to 16 show a HANTEI.names file, a HANTEI.data file, and a HANTEI.cases file, respectively. In FIG. 14, the first line: “i-mode (registered trademark), PC, EZweb” shows that each Web page is classified into either of a Web page type intended for i-mode (registered trademark) mobile phones, a Web page type intended for PCs, and a Web page type intended for EZweb (registered trademark) mobile phones according to the determination rule created. The second and later lines: “size: continuous”, “tag_A: 0,1”, . . . show items of the contents of the Web page feature information database 204, respectively. “size” represents the Web page size and “tag_A” represents presence or absence of an <A> tag (if an <A> tag is included, the corresponding feature value is set to 1, otherwise the corresponding feature value is set to 0). In the HANTEI.data file of FIG. 15, each line has the values of items listed in the example of the HANTEI.names file of FIG. 14 for the corresponding Web page and the determined type of the corresponding Web page. Only the feature values associated with “size” and “tag A” are shown in FIG. 15. For example, the first line shows that the corresponding Web page has a feature value of 10 for the size of the Web page (Web page size) and a feature value of 1 for tag_A (i.e., the corresponding Web page includes an <A> tag) and the Web page type is an i-mode (registered trademark) type (i.e., the corresponding Web page is a Web page intended for i-mode (registered trademark) mobile phones). The example of the HANTEI.cases file as shown in FIG. 16 is written in the same form as the HANTEI.data file as shown in FIG. 15, but differs from the HANTEI.data file in that target Web pages differ from those provided for the HANTEI.data file.

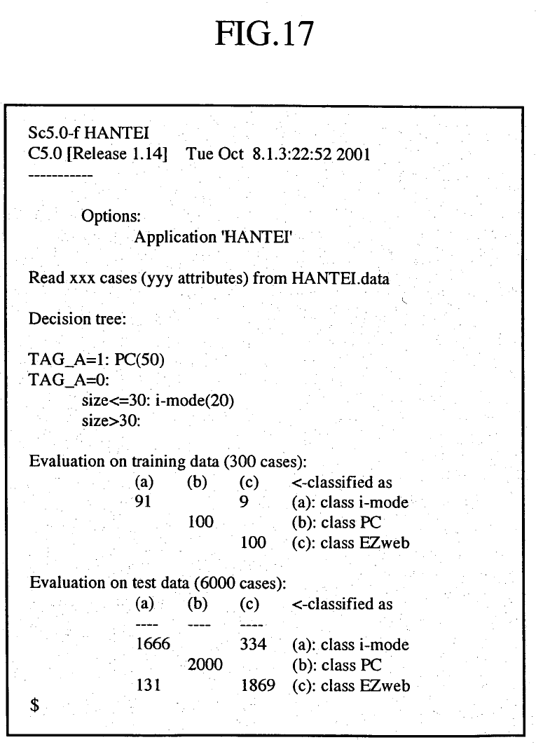

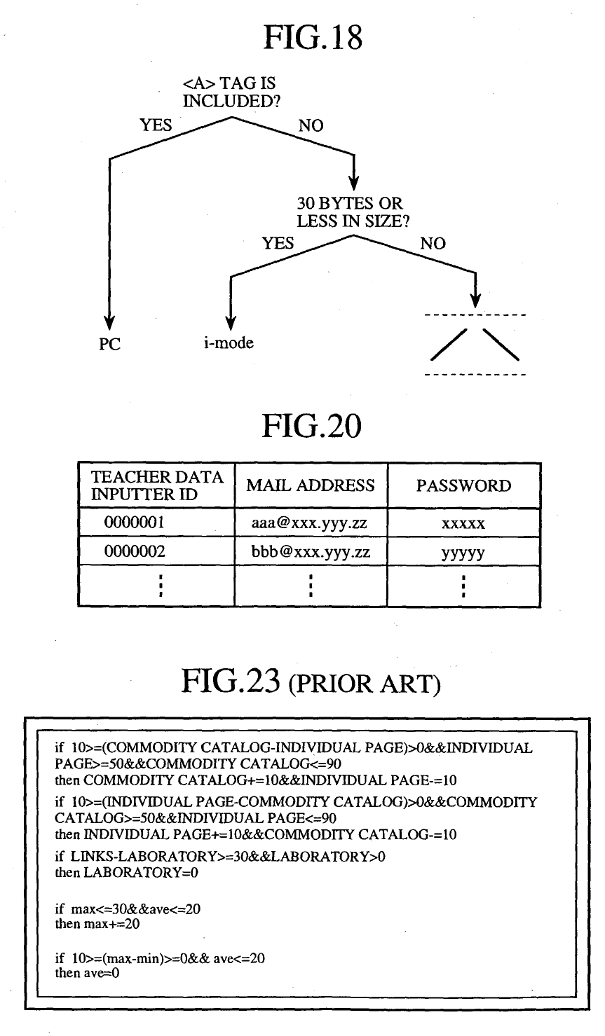

The data mining tool See5/C5.0 creates a processing result as shown in FIG. 17 from the made-for-machine-learning feature value and teacher data database 210 which consists of the HANTEI.data file shown in FIG. 15. This processing result corresponds to the combination of the determination rule database 213 and the determination result database 215. A set of statements specified by “Decision tree:” of FIG. 17 shows the created determination rule and corresponds to the decision tree shown in FIG. 18. The uppermost node of this decision tree is “Whether or not an <A> is included?”, as shown in FIG. 18, and it is determined that the Web page in question is a Web page intended for PCs if “Yes” in the uppermost node, whereas the decision tree advances to a child node: “Whether or not the Web page size is 30 bytes or less?” if “No” in the uppermost node. When the Web page size is 30 bytes or less, it is determined that the Web page in question is a Web page intended for i-mode (registered trademark) mobile phones. In contrast, if not, the decision tree advances to a child node not shown in the figure. Another set of statements specified by “Evaluation on training data:” of FIG. 17 shows the accuracy of this determination rule. The accuracy of the determination rule for the plurality of Web pages whose feature values and teacher data are stored in the HANTEI.data file, i.e., the made-for-machine-learning feature value and teacher data database 210 is shown in the other set of statements. In this example, 91 Web pages of 100 Web pages, which are determined to be Web pages intended for i-mode (registered trademark) mobile phones by the teacher data inputter, are correctly determined, whereas remaining 9 Web pages are erroneously determined to be Web pages intended for EZweb (registered trademark) mobile phones. On the other hand, a further set of statements specified by “Evaluation on test data:” of FIG. 17 also shows the accuracy of this determination rule. The accuracy of the determination rule for the plurality of Web pages whose feature values and teacher data are stored in the HANTEI.cases file, i.e., the made-for-verification feature value and teacher data database 211 is shown in the further set of statements In other words, “Evaluation on test data:” of FIG. 17 corresponds to the determination result database 215. In the example of FIG. 17, 1666 Web pages of 2000 Web pages, which are determined to be Web pages intended for i-mode (registered trademark) mobile phones by the teacher data inputter, are correctly determined, whereas remaining 334 Web pages are erroneously determined to be Web pages intended for EZweb (registered trademark) mobile phones. In addition, 1869 Web pages of 2000 Web pages, which are determined to be Web pages intended for EZweb (registered trademark) mobile phones by the teacher data inputter, are correctly determined, whereas remaining 131 Web pages are erroneously determined to be Web pages intended for i-mode (registered trademark) mobile phones.

Needless to say that the above-mentioned concrete example is an example using the data mining tool See5/C5.0 and the determination rule created according to the HANTEI.names file, i.e., the contents of the Web page feature information database 204 shown in FIG. 14 differs from the one as shown in FIG. 18. The plurality of predetermined types are not limited to the Web page type intended for PCs, the Web page type intended for i-mode (registered trademark) mobile phones, and the Web page type intended for EZweb (registered trademark) mobile phones, and can include Web page types intended for other portable terminals such as a Web page type intended for J-sky mobile phones.

As mentioned above, in accordance with embodiment 2 of the present invention, since the structured document type determination system can efficiently derive an optimum determination rule from a large amount of Web pages collected using a crawl or the like based on a list of features which is disposed in advance, the present embodiment offers an advantage of being able to negate the need to use a trial-and-error method for creating a determination rule. Furthermore, since the structured document type determination system according to this embodiment 2 can derive the optimum determination rule whenever new Web pages are collected using a crawl or the like and the contents of the Web page database 201 are updated, the structured document type determination system can accommodate any change in each Web page promptly.

In addition, when a new feature is added to each Web page or a new feature is discovered in each Web page, since the manager can create a new optimum determination rule by taking the value of the new feature into consideration by only adding the new feature to the Web page feature information database 204 through the Web page feature information database editing unit 206, the present embodiment offers an advantage of being able to negate the need to use a trial-and-error method for creating a determination rule even in this case.

Embodiment 3.

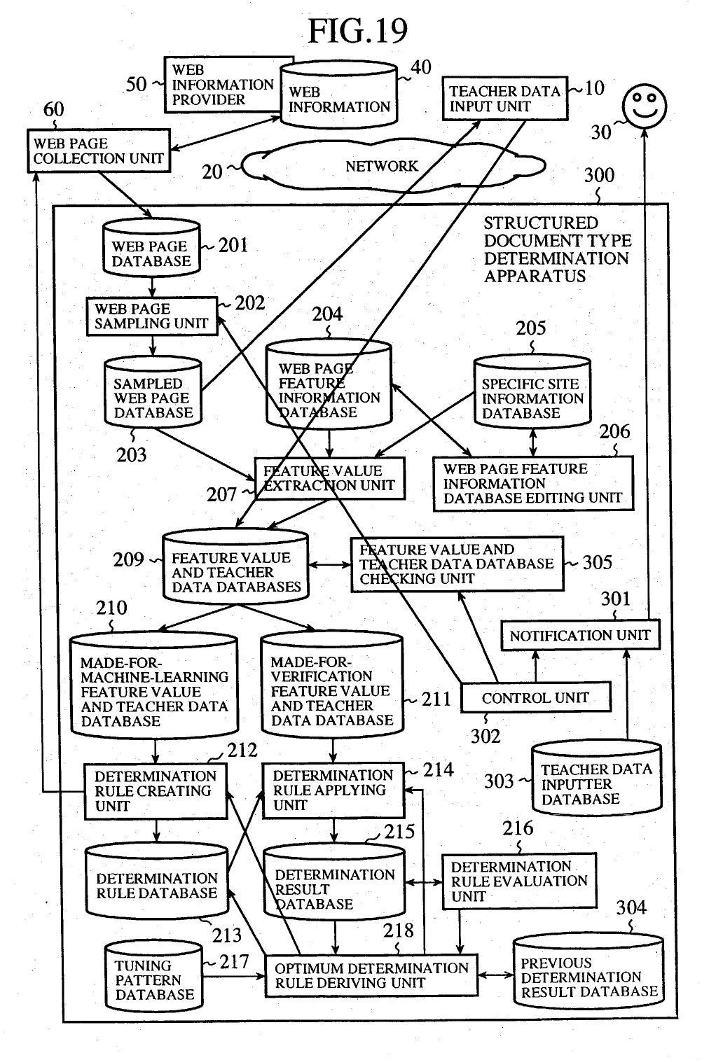

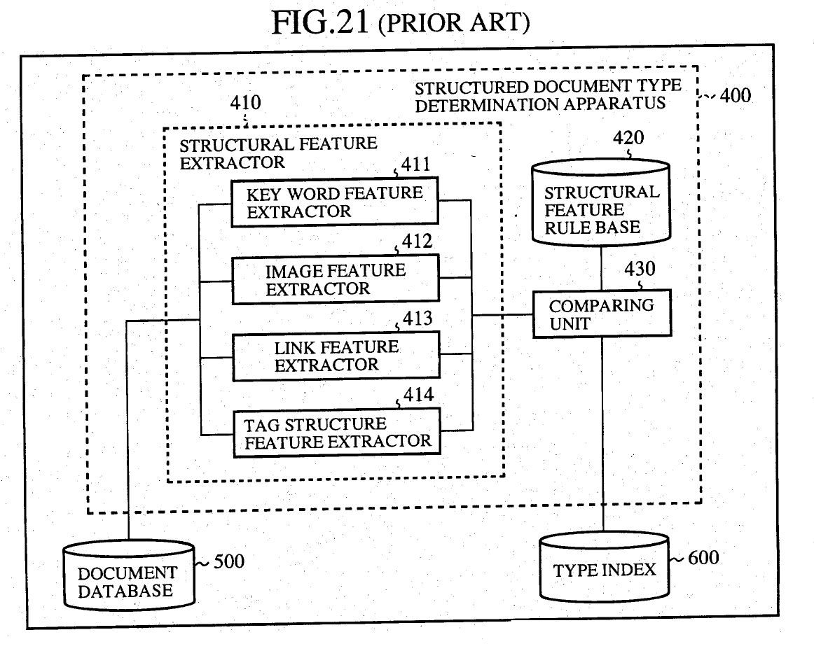

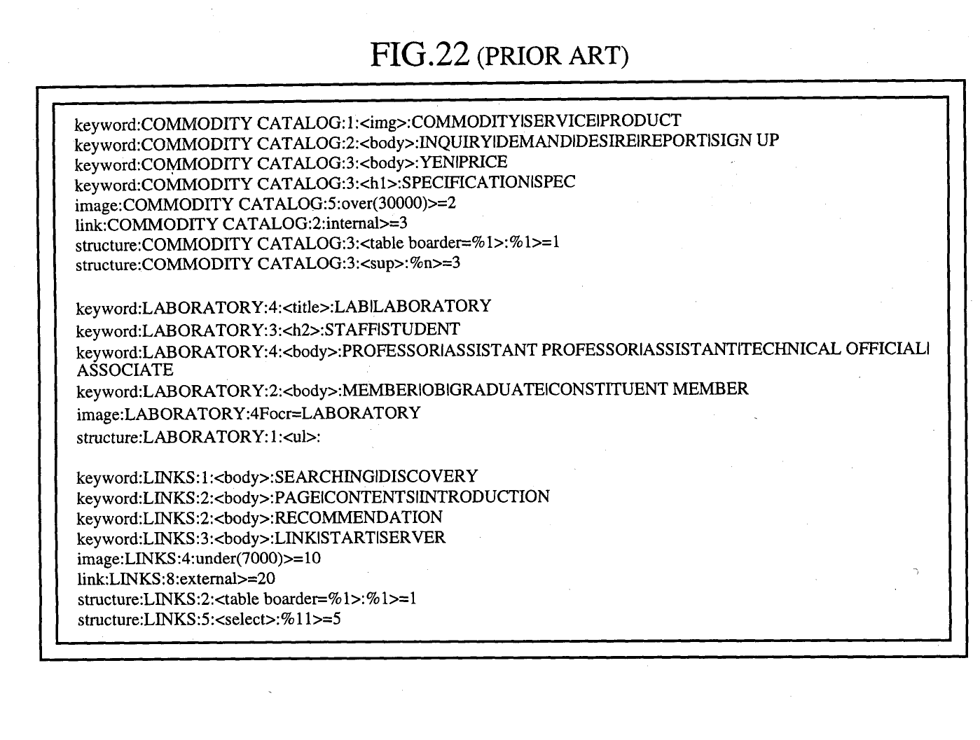

FIG. 19 is a block diagram showing the structure of a structured document type determination system according to embodiment 3 of the present invention. In the figure, the same reference numerals as shown in FIG. 5 denote the same components as those of the structured document type determination system according to above-mentioned embodiment 2 or like components, and therefore the explanation of those components will be omitted hereafter.

Furthermore, in FIG. 19, reference numeral 10 denotes a teacher data input unit (teacher data input means) connected to a structured document type determination apparatus 300 by way of a network 20, such as the Internet or an intranet, for acquiring the contents of a sampled Web page database 203 by way of the network 20 and for storing teacher data input by each teacher data inputter 30 in a feature value and teacher data database 209 by way of the network 20, reference numeral 303 denotes a teacher data inputter database for storing information on each teacher data inputter 30, reference numeral 301 denotes a notification unit (notification means) for making a request of each teacher data inputter 30 registered in the teacher data inputter database 303 for inputting of teacher data through the teacher data input unit 10, reference numeral 302 denotes control unit (control means) for starting the structured document type determination apparatus 300 every time it is instructed by a manager or at predetermined intervals so as to update the contents of the sampled Web page database 203 and to acquire a new optimum determination rule, reference numeral 304 denotes a previous determination result database for storing previous determination results acquired by the determination rule applying unit 214 according to a previous optimum determination rule, reference numeral 305 denotes a feature value and teacher data database checking unit (control means) for checking whether all data are provided in the feature value and teacher data database 209 according to an instruction from the control unit 302, and reference numeral 60 denotes a collection unit (collection means) for collecting Web pages from Web information 40 provided by Web information providers 50, such as Web sites connected to the network 20, so as to update the contents of the Web page database 201.

Next, a description will be made as to the operation of the structured document type determination system according to embodiment 3 of the present invention. Since the structured document type determination system according to embodiment 3 of the present invention operates basically in the same manner that the structured document type determination system according to above-mentioned embodiment 2 does, only a characterized operation of the structured document type determination system of embodiment 3 will be explained hereafter.

The control unit 302 starts a Web page sampling unit 202 every time it is instructed by the manager or at predetermined intervals and simultaneously causes the feature value and teacher data database checking unit 305 to check whether all data are provided in the feature value and teacher data database 209. When all data are provided in the feature value and teacher data database 209, the control unit 302 starts the notification unit 301. In this case, the feature value and teacher data database checking unit 305 checks whether inputting of teacher data are all completed for last, updating of the sampled Web page database 203. As described later, teacher data are not necessarily provided for each of all added Web pages and all updated sampled Web pages.

The notification unit 301 makes a request of at least one teacher data inputter 30, information on which is stored in the teacher data inputter database 303, for inputting of teacher data through the teacher data input unit 10 by way of the network 20. In this case, the notification unit 301 makes a request for inputting of teacher data by using a means such as an electronic mail. FIG. 20 is a diagram showing an example of the teacher data inputter database 303 in which a teacher data inputter ID, a mail address, and a password are stored for each teacher data inputter. A plurality of teacher data inputters 30 can be registered in the teacher data inputter database 303, as shown in the figure. When making a request for inputting of teacher data, the notification unit 301 can instruct each teacher data inputter to input teacher data for all or part of Web pages stored in the sampled Web page database 203 (e.g., all or part of Web pages newly added to the sampled Web page database 203 and updated Web pages stored in the sampled Web page database 203). This is because the notification unit 301 need not forcedly cause each teacher data inputter to input teacher data for all Web pages stored in the sampled Web page database 203 and Web pages whose teacher data are blank can be excluded from target Web pages to be evaluated.

Each teacher data inputter 30, which receives the notification, can acquire the contents of the sampled Web page database 203, e.g., newly added Web pages and updated Web pages by using the teacher data input unit 10 by way of the network 20. The teacher data inputter 30 then determines the type of each acquired Web page and stores teacher data which is the determination result in the feature value and teacher data database 209 by way of the network 20. The control unit 302 checks whether or not there are a plurality of different teacher data input by a plurality of teacher data inputters 30 for each acquired Web page through the feature value and teacher database checking unit 305, and determines only one teacher data based on majority rule when there are a plurality of different teacher data input by a plurality of teacher data inputters 30 for each acquired Web page.

The optimum determination rule deriving unit 218 determines whether either the previous optimum determination rule or the new optimum determination rule has a higher degree of accuracy by comparing the new determination results acquired by the determination rule applying unit 214 and stored in the determination result database 215 with the previous determination results stored in the previous determination result database 304, and stores the determined optimum determination rule having a higher degree of accuracy in the determination rule database 213. The optimum determination rule deriving unit 218 has stored the previous determination results acquired by the determination rule applying unit 214 according to the previous optimum determination rule in the previous determination result database 304 after previously updating the sampled Web page database 203.

The collection unit 60 collects Web pages from the Web information 40 provided by Web information providers 50 by using a crawler or the like when it is instructed by the manager or at predetermined intervals. In this case, the collection unit 60 collects at least Web pages newly added to the Web information 40 and updated Web pages stored in the Web information 40. The collection unit 60 can collect only Web pages that are classified into the plurality of predetermined types according to the current optimum determination rule stored in the determination rule database 213 from the Web information 40 by way of the network 20 so as to store them in the Web page database 201. As a result, since the structured document type determination system can collect only Web pages associated with the plurality of specific types determined in advance, it can efficiently derive the optimum determination rule.

As mentioned above, in accordance with embodiment 3 of the present invention, since the structured document type determination system can automatically derive an optimum determination rule from a large amount of Web pages collected using a crawl or the like based on the list of features which is disposed in advance when instructed by a manager or at predetermined intervals, the present embodiment offers an advantage of being able to negate the need to use a trial-and-error method for creating a determination rule. Furthermore, since the structured document type determination system according to this embodiment 3 can automatically derive the optimum determination rule whenever the contents of the Web page database 201 is updated, the structured document type determination system can accommodate any change in each Web page promptly while automatically maintaining or improving the accuracy of determination of the types of Web pages.

Needless to say that this embodiment 3 can be also applied to embodiment 1 and the same advantages can be provided. Furthermore, the structured document type determination system as explained in either of above-mentioned embodiments 1 to 3 can be implemented via a computer and a program executed by the computer.

Many widely different embodiments of the present invention may be constructed without departing from the spirit and scope of the present invention. It should be understood that the present invention is not limited to the specific embodiments described in the specification, except as defined in the appended claims.

What is claimed is:

1. A structured document type determination system comprising:
a structured document database for storing a plurality of structured documents collected by way of a network;
a teacher data input means for inputting, as teacher data, a type of each of the plurality of structured documents stored in said structured document database;
a determination rule creating means for creating a determination rule used for determining a type of each of the plurality of structured documents based on a plurality of structured documents stored in said structured document database and the teacher data; and
a determination rule applying means for determining the type of a structured document that exists on said network according to the determination rule created by said determination rule creating means.

2. The structured document type determination system according to claim 1, wherein said determination rule creating means creates a plurality of determination rules and then determines the type of each of a plurality of structured documents according to each of the plurality of determination rules, and wherein said structured document type determination system is provided with a determination rule selecting means for making an evaluation of each of the plurality of determination rules based on determination results from said determination rule applying means and the teacher data so as to select one determination rule from among the plurality of determination rules based on an evaluation result.

3. The structured document type determination system according to claim 2, further comprising: a structured document sampling means for sampling a plurality of arbitrary structured documents from said structured document database; a sampled structured document database for storing the plurality of structured document sampled by said structured document sampling means; a structured document feature information database for storing a list of features each of which is a measure to classify a plurality of structured documents into a plurality of predetermined types and each of which can be extracted from structured documents; a feature value extraction means for extracting a value of each of the plurality of features (referred to as a feature value from here on) from each of the plurality of structured documents stored in said sampled structured document database according to the list of features stored in said structured document feature information database; a feature value and teacher data database including feature values extracted by said feature value extraction means and the teacher data input by said teacher data input means for each of the plurality of structured documents stored in said sampled structured document database; a made-for-machine-learning feature value and teacher data database that is a part of said feature value and teacher data database; and a made-for-verification feature value and teacher data database that is the remainder of said feature value and teacher data database, wherein said determination rule creating means creates the plurality of determination rules each of which is used to classify each of the plurality of structured documents into one of the plurality of types based on said made-for-machine-learning feature value and teacher data database, and said determination rule applying means determines which one of the plurality of types each of the plurality of structured documents whose feature values and teacher data are stored in said made-for-verification feature value and teacher data database is classified into according to each of the plurality of determination rules, and wherein said determination rule selecting means includes a determination rule evaluation means for making an evaluation of each of the plurality of determination rules by comparing the determination results acquired by said determination rule applying means with the teacher data stored in said made-for-verification feature value and teacher data database, a tuning pattern database for storing a list of tuning patterns used for tuning of the creation of the plurality of determination rules, and an optimum determination rule deriving means for selecting a tuning pattern from said tuning pattern database one by one so as to deliver the selected tuning pattern to said determination rule creating means, and for repeating a series of processes, such as causing said determination rule creating means to create a determination rule again according to the selected tuning pattern, causing said determination rule applying means to make a determination of the type of each of the plurality of structured documents stored in said made-for-verification feature value and teacher data database again according to the created determination rule and causing said determination rule evaluation means to make an evaluation of the created determination rule, until the determination rule creation and the evaluation are completed for all of the plurality of tuning patterns stored in said tuning pattern database, so as to derive an optimum determination rule from among a plurality of determination rules acquired during the above processes.

4. The structured document type determination system according to claim 3, further comprising a structured document feature information database editing means for editing the list of features stored in said structured document feature information database.

5. The structured document type determination system according to claim 3, further comprising a collection means for collecting structured documents by way of a network and for updating contents of said structured document database, a control means of starting said structured document type determination system in order to update contents of said sampled structured document database and to acquire a new optimum determination rule, a teacher data inputter database for storing information on one or more inputters who can input teacher data, a notification means for making a request of one or more teacher data inputters registered in said teacher data inputter database for inputting of teacher data by way of said teacher data input means, and a previous determination result database for storing previous determination results acquired by said determination rule applying means according to a previous optimum determination rule, wherein said optimum determination rule deriving means makes a evaluation of the new optimum determination rule by comparing the previous determination results stored in said previous determination result database with new determination results acquired by said determination rule applying means according to the new optimum determination rule.

6. The structured document type determination system according to claim 5, wherein said teacher data input means acquires the contents of said sampled structured document database by way of the network, and stores input teacher data in said feature value and teacher data database by way of the network.

7. The structured document type determination system according to claim 5, wherein said control means starts said structured document sampling means every time it is instructed by a manager or at predetermined intervals so as to update the contents of said sampled structured document database.

8. The structured document type determination system according to claim 5, wherein said control means checks whether or not all data are provided in said feature value and teacher data database every time it is instructed by a manager or at predetermined intervals, and starts said notification means when all data are provided in said feature value and teacher data database.

9. The structured document type determination system according to claim 5, wherein said notification means provides an instruction to input teacher data for all of part of structured documents stored in said sampled structured document database for one or more teacher data inputters registered in said teacher data inputter database.

10. The structured document type determination system according to claim 5, wherein said optimum determination rule deriving means determines whether either the previous optimum determination rule or the new optimum determination rule has a high degree of accuracy by comparing the new determination results stored in said determination result database with the previous determination results stored in said previous determination result database.

11. The structured document type determination system according to claim 5, wherein when there are different teacher data input by a plurality of teacher data inputters for a same structured document, said control means determines only one of them based on majority rule.

12. The structured document type determination system according to claim 5, wherein said collection means collects only structured documents that are classified into either one of the plurality of predetermined types according to the current optimum determination rule from the network, and stores them in said structured document database.

13. The structured document type determination system according to claim 1, wherein said determination rule creating means creates the determination rule by using a data mining tool.

14. The structured document type determination system according to claim 1, wherein the plurality of structured documents are Web pages.

15. The structured document type determination system according to claim 14, further comprising a specific site information database for storing a list of URLs (Uniform Resource Locators) of specific Web pages, wherein said feature value extraction means extracts a feature value associated with a link to each URL, which is included in the list stored in said specific site information database, from each Web page stored in said sampled structured document database.

16. The structured document type determination system according to claim 14, wherein the list of features stored in said structured document feature information database includes either one or plural ones of following features:
(1) A number of use of each of all tags which can constitute Web pages
(2) A number of use of each of all tags which can constitute Web pages and which includes each attribute
(3) A number of use of each of all tags which can constitute Web pages and which includes an attribute having a predetermined continuous value or discrete value
(4) A size of each Web page
(5) A size of display of each Web page
(6) Character code type used in each Web page
(7) A number of use of half-width kana characters
(8) A number of use of image characters (“emoji”)
(9) Image file format type
(10) Presence or absence of each predetermined character string pattern included in a URL which is an identifier of each Web page
(11) A length of the URL which is an identifier of each Web page
(12) A extension of the URL which is an identifier of each Web page
(13) A number of external links
(14) A number of internal links

17. The structured document type determination system according to claim 14, wherein the list of features stored in said structured document feature information database includes presence or absence of a predetermined tag sequence.

18. The structured document type determination system according to claim 14, wherein the list of features stored in said structured document feature information database includes a number of link sources which are determined to be each Web page type and a number of link destinations which are determined to be each Web page type.

19. The structured document type determination system according to claim 14, wherein the list of features stored in said structured document feature information database includes presence or absence of change in contents of each Web page when access source information is changed.

20. The structured document type determination system according to claim 14, wherein the list of features stored in said structured document feature information database includes a number of links to each Web page stored in a specific site information database and a number of links from each Web page stored in said specific site information database.

21. The structured document type determination system according to claim 14, wherein the plurality of types include at least a Web page type intended for i-mode (registered trademark) mobile phones and a Web page type intended for personal computers.

22. A structured document type determination method comprising the steps of:
sampling a plurality of arbitrary structured documents from a structured document database for storing structured documents so as to create a sampled structured document database;
providing a list of features each of which is a measure to classify a plurality of structured document into a plurality of predetermined types and each of which is to be extracted from each of the plurality of structured documents;
by extracting a value of each of the plurality of features (referred to as a feature value from here on) from each of the plurality of structured documents stored in said sampled structured document database according to the list of features and by inputting teacher data which is a result of determining which one of the plurality of types each of the plurality of structured documents stored in said sampled structured document database is classified into, creating a feature value and teacher data database including the input teacher data and extracted feature values for each of the plurality of structured documents stored in said sampled structured document database;
by dividing said feature value and teacher data database into two portions, creating both a made-for-machine-learning feature value and teacher data database and a made-for-verification feature value and teacher data database;
creating a determination rule used for determining which one of the plurality of types a structured document is classified into based on said made-for-machine-learning feature value and teacher data database by using a data mining tool;
determining which one of the plurality of types each of a plurality of structured documents whose feature values and teacher data are stored in said made-for-verification feature value and teacher data database is classified into according to the determination rule so as to produce determination results;
making an evaluation of the determination rule by comparing the determination results with the teacher data stored in said made-for-verification feature value and teacher data database; and
selecting a tuning pattern from a list of tuning patterns used for tuning of the creation of the determination rule one by one so as to deliver the selected tuning pattern to said determination rule creating step, and repeating a series of processes, such as causing said determination rule creating step to create a determination rule again according to the selected tuning pattern, causing said determining step to make a determination of the type of each of the plurality of structured documents stored in said made-for-verification feature value and teacher data database again according to the created determination rule and causing said determination rule evaluation step to make an evaluation of the created determination rule, until the determination rule creation and the evaluation are completed for all the tuning patterns in said tuning pattern list, so as to derive an optimum determination rule from among a plurality of determination rules acquired during the above processes.
